(19) United States
(12) Patent Application Publication
(10) Pub. No.: US 2013/0002682 A1
(43) Pub. Date: Jan. 3, 2013

(54) ELECTRONIC DEVICE WITH FUNCTION OF MAPPING HUMAN MOVEMENT TO DIGITAL MODEL AND METHOD THEREOF

(75) Inventor: QIANG YOU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/220,636

(22) Filed: Aug. 29, 2011

(30) Foreign Application Priority Data
Jun. 30, 2011 (CN) 201110181819.9

(51) Int. Cl. G06T 13/80

(52) U.S. Cl. 345/473

(57) ABSTRACT

An electronic device includes a human movement data receiving module, a digital model providing module, a human movement mapping module, and an animated image displaying module. The human movement data receiving module receives human movement data produced by the gyroscopes which are attached to different parts of a human. Each gyroscope is assigned an identifier. The digital model providing module provides a digital model whose shape is similar to the shape of the human. The digital model includes a number of portions associated with the human movement data of one of the gyroscopes. The human movement mapping module identifies the identifiers of the gyroscopes to determine the gyroscopes, and maps the human movement data produced by the determined gyroscopes onto the portions of the digital model associated with the determined gyroscopes to form an animated image. The animated image displaying module displays the animated image on the display unit.

### BACKGROUND

1. Technical Field

The present disclosure relates to electronic devices and, particularly, to an electronic device with a function of mapping human movement to a digital model and a method thereof.

2. Description of Related Art

In general, a user may dance for practice or to express joy. After dancing, if she wants to see the dance steps which she made, and the differences between her dance steps and the standard dance steps, it is often not easy to do so.

Therefore, what is needed is an electronic device with a function of mapping human movement to a digital model to overcome the described limitations.

### BRIEF DESCRIPTION OF THE DRAWINGS

FIG. 1 is a block diagram of the hardware infrastructure of an electronic device capable of mapping human movement to a digital model, in accordance with an exemplary embodiment.

FIG. 2 is a flowchart of a method for mapping the human movement to the digital model implemented by the electronic device of FIG. 1, in accordance with an exemplary embodiment.

### DETAILED DESCRIPTION

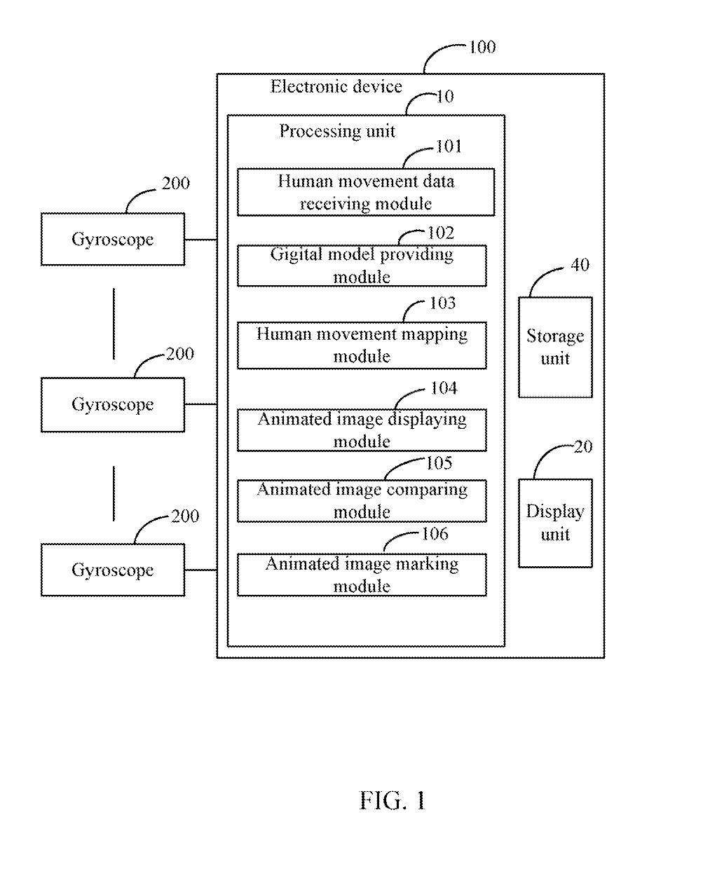

FIG. 1 shows an electronic device 1 with a function of mapping human movement to a digital model, in accordance with an exemplary embodiment. The electronic device 1 includes a processing unit 10 and a display unit 20. The processing unit 10 includes a human movement data receiving module 101, a digital model providing module 102, a human movement mapping module 103, and an animated image displaying module 104.

The human movement data receiving module 101 is configured to receive human movement data produced by a number of gyroscopes 200 which are respectively attached on different parts of the human. The parts of the human may be the legs, the head, the arms, or other parts. Each gyroscope 200 is assigned an identifier to enable the identification of it. The number of the gyroscopes 200 is determined according to the number of parts of the human. The human movement data includes an orientation and an angular velocity of the movement of the parts of the human. In one embodiment, each of the number of gyroscopes 200 is wirelessly connected to the electronic device 100.

The digital model providing module 102 is configured to provide a digital model whose basic shape is similar to the shape of the human actor. The digital model includes a number of portions, each of which is associated with a gyroscope 200, and is controllable to perform or create or recreate the same actions as the human according to the human movement data produced by the associated gyroscope 200.

The human movement mapping module 103 is configured to identify the identifiers to determine the gyroscopes 200, and to map the human movement data produced by the determined gyroscopes 200 onto or into the portions of the digital model associated with the determined gyroscopes 200, to form an animated image, thereby enabling the digital model to perform exactly the same actions as the human.

The animated image displaying module 104 is configured to display the animated data as a virtual human figure on the display unit 20.

Referring to FIG. 1 again, the electronic device 100 further includes a storage unit 40 which is configured to store a number of standard animated images. The processing unit 10 includes an animated image comparing module 105 and an animated image marking module 106. The animated image comparing module 105 is configured to compare the generated animated image with a standard static image to determine any differences, and to generate correction indications according to any determined differences. The animated image marking module 106 is configured to highlight or mark the generated correction indications on the animated image displayed on the display unit 20.

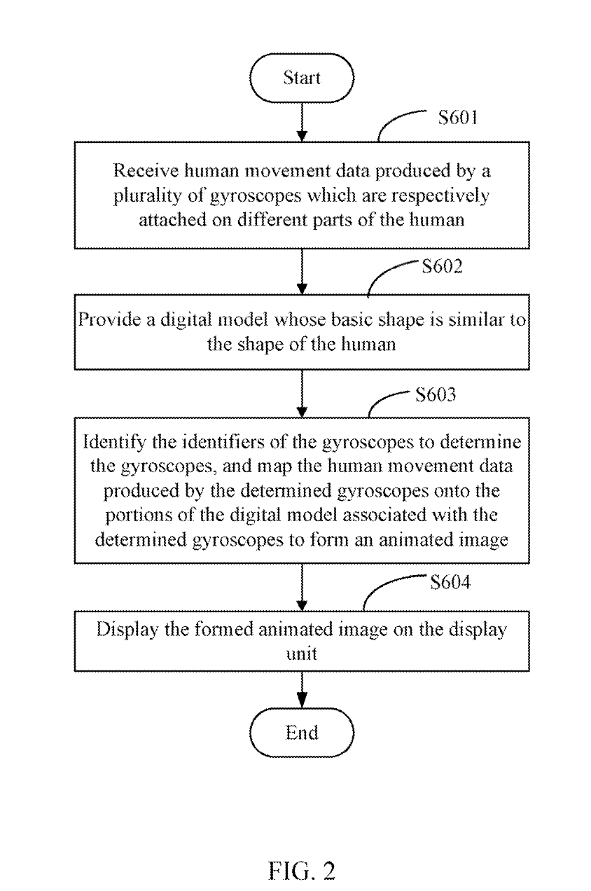

FIG. 2 is a flowchart of a method for mapping human movement to a digital model implemented by the electronic device of FIG. 1, in accordance with an exemplary embodiment.

In step S601, the human movement data receiving module 101 receives substantially continuous human movement data produced by a number of gyroscopes 200 which are attached on different parts of the human.

In step S602, the digital model providing module 102 provides a digital model whose basic shape is similar to the shape of the human.

In step S603, the human movement mapping module 103 identifies the identifiers to determine the gyroscopes 200, and maps the human movement data produced by the determined gyroscopes 200 onto or into the portions of the digital model associated with the determined gyroscopes 200, to form an animated image.

In step S604, the animated image displaying module 104 displays the animated image on the display unit 20.

The method further includes the following steps: the animated image comparing module 105 compares the generated animated image with the standard animated image to determine any differences, and generates correction indications according to any determined differences, and the animated image marking module 106 highlights or marks the generated correction indications on the animated image.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. An electronic device with a function of mapping human movement to a digital model, comprising:
a display unit; and
a processing unit comprising:
a human movement data receiving module configured to receive human movement data produced by a plurality of gyroscopes which are respectively attached on different parts of a human, each gyroscope is assigned an identifier;
a digital model providing module configured to receive human movement data from the human movement data receiving module, and provide a digital model whose basic shape is similar to the shape of the human, wherein the digital model comprises a plurality of portions, each of which is associated with the human movement data from one of the gyroscopes;
a human movement mapping module configured to identify the identifiers of the gyroscopes to determine the gyroscopes, and to map the human movement data produced by the determined gyroscopes onto the portions of the digital model associated with the determined gyroscopes, to form an animated image; and
an animated image displaying module configured to display the formed animated image on the display unit.

2. The electronic device as described in claim 1, wherein each of the plurality of gyroscopes is wirelessly connected to the electronic device.

3. The electronic device as described in claim 1, further comprising:
a storage unit configured to store a plurality of standard animated images;
the processing unit further comprising:
an animated image comparing module configured to compare the generated animated image with one of the standard animated images to determine any differences, and generate correction indications according to any determined differences; and
an animated image marking module configured to mark the correction indications on the animated image.

4. The electronic device as described in claim 1, wherein the human movement data comprises an orientation and an angular velocity of the movement of the parts of the human.

5. A method for mapping human movement to a digital model implemented by an electronic device, wherein the electronic device comprises a display unit, the method comprising:
receiving human movement data produced by a plurality of gyroscopes which are respectively attached on different parts of the human, each gyroscope is assigned an identifier;
providing a digital model whose basic shape is similar to the shape of the human, wherein the digital model comprises a plurality of portions, each of which is associated with the human movement data from one of the gyroscopes;
identifying the identifiers of the gyroscopes to determine the gyroscopes, and mapping the human movement data produced by the determined gyroscopes onto the portions of the digital model associated with the determined gyroscopes to form an animated image; and
displaying the formed animated image on the display unit.

6. The method as described in claim 5, wherein the electronic device further comprises a storage unit for storing a plurality of standard animated images, the method further comprises:
comparing the generated animated image with one of the standard animated images to determine any differences, and generating correction indications according to any determined differences; and
marking the correction indications on the animated image displayed on the display unit.
